(19) United States
(12) Patent Application Publication
(10) Pub. No.: US 2021/0156212 A1
(43) Pub. Date: May 27, 2021

(54) DOWNHOLE VIBRATION TOOL FOR DRILL STRING

(71) Applicant: Ulterra Drilling Technologies, L.P., Fort Worth, TX (US)

(72) Inventors: Thomas A. Damian, Dallas, TX (US); Jason C. Maw, Beaumont (CA); Matthew B. Roseman, Fort Worth, TX (US)

(73) Assignee: Ulterra Drilling Technologies, L.P., Fort Worth, TX (US)

(21) Appl. No.: 17/101,416

(22) Filed: Nov. 23, 2020

Related U.S. Application Data
(60) Provisional application No. 62/939,919, filed on Nov. 25, 2019.

(51) Int. Cl. E21B 31/00; E21B 34/06; E21B 47/18; E21B 21/10

(52) U.S. Cl. CPC E21B 31/005; E21B 34/06; E21B 2200/06; E21B 21/103; E21B 47/18

(57) ABSTRACT

The present disclosure relates to a friction reduction tool having a housing for connecting the friction reduction tool to a drill string or coiled tubing; a force converter within the housing and having a stator, a helical rotor, and a rotational cavity passageway for conveying drilling fluid between the stator and the helical rotor; and a valve assembly; wherein the helical rotor has a bore which extends through the helical rotor and which defines an alternative passageway for the drilling fluid; and wherein the rotational cavity passageway and the alternative passageway are in fluidic communication with the valve assembly.

### PRIORITY

This application claims priority to U.S. Provisional Application No. 62/939,919, filed on Nov. 25, 2020, which is incorporated herein by reference.

### FIELD

The present disclosure relates generally to downhole tools which vibrate a drill string and coil tubing to reduce friction during oil and gas drilling and well workover operations.

### BACKGROUND

Friction between a drill string or coiled tubing lowered into an open hole (uncased wellbore) or cased wellbore is a common problem in highly deviated or complex wells, such as horizontal wells, extended wells, and multi-lateral wells, which are formed using directional drilling techniques. The resulting drag impedes pipe movement in and out of the hole, as well as, in the case of drill strings, rotation of the drill string, especially once the drill string or coiled tubing stops moving and static friction takes over. When drilling a wellbore, the friction also affects the rate of penetration (ROP) of the drill bit. The full amount of the weight that the drilling operator is trying to put on the bit (the “weight on bit”) is not being transferred to the bit when there is drag.

A “drill string” refers usually to the combination of jointed drill pipe, a drill bit, e.g., a fixed cutter bit or a roller cone bit, and other tools that are rotated from the surface to drill through subterranean rock formations to establish a wellbore for recovering deposits of oil and gas from the rock. However, coiled tubing can be used instead of jointed drill pipe to make up a drill string. In either case, drilling fluid or “mud” is pumped through the drill string under high pressure and then circulated back up to the surface through the annulus formed between the drill string and sides of the wellbore after it exits the face of the drill bit. The drilling fluid acts as a medium for evacuating rock cuttings. When a positive displacement or “mud” motor is placed within the drill string, the flow of drilling fluid also powers the mud motor.

Coiled tubing, which is a continuous pipe stored on reels that can be quickly moved in and out of wellbores, can also be used for different applications, such fishing operations, clean outs, operating downhole equipment (such as shiftable sleeves), and in other types of completion and work over operations. Both types of uses of coiled tubing can suffer from the problems associated with friction noted above. A reference to “drill string” is therefore intended to include drill strings that use jointed pipe or coiled tubing for drilling, as well as use of coiled tubing in other applications involving highly deviated or complex wells.

Drill strings typically include various downhole tools to address various issues that may arise during drilling and/or through tubing. For example, to reduce the effects of friction, specialized downhole tools are inserted into the drill string for vibrating the drill string. One well-known example of such a tool is the Agitator™ sold by NOV. Although some of these types of tools generate lateral and torsional vibrations, most generate axial oscillations in the drill string. The vibrations in the drill string help to reduce the effects of friction by generating cyclical pressure waves within the drilling fluid.

One example of these types of downhole tools is described in U.S. Pat. No. 6,237,701, which discloses suction pressure pulses generated within a borehole by closing a valve that interrupts the flow of a drilling fluid (e.g., drilling mud) circulating through one or more high velocity flow courses within the borehole. Arresting flow of the drilling mud through the high velocity flow course(s) generates suction pressure pulses of substantial magnitude over a face of the drill bit. The suction pressure pulses provide a sufficient differential pressure that weakens the rock through which the drill bit is advancing and also increase the force with which the drill bit is being advanced toward the rock at the bottom of the borehole.

U.S. Pat. No. 6,431,294 describes a percussion drill having a tubular fluid transmitting body, with a drill bit mounted on a drill bit support itself mounted in body via a spring and salines. A mass is spring mounted in the body and is movable to impact on a face of the support. Mounted to the mass is a rotating valve comprising two valve plates. Each plate, defines a slot, such that rotation of one of the valve plates relative to the other moves the slots, into and out of alignment; the change in alignment of the slots, alters the flow of drilling fluid through the valve, so altering the drilling fluid pressure force acting on the mass, so causing mass to push against the spring, and impact on the drill bit support providing a percussive act ion at the drill bit.

U.S. Pat. Nos. 8,162,078 and 9,222,312 describe an apparatus for vibrating a downhole drill string operable to have a drilling fluid pumped therethrough. The apparatus comprises a tubular body securable to the drill string and having a central bore therethrough, a valve in the tubular body for venting the drilling fluid out of the drill string and a valve actuator for cyclically opening and closing the valve. The method comprises pumping a drilling fluid down the drill string and cyclically venting the drilling fluid through the valve so as to cyclically reduce the pressure of the drilling fluid in the drill string. The valve may comprise a tubular body port and a corresponding rotor port selectably alignable with the tubular body port as the rotor rotates within the central bore. The valve actuator may comprise at least one vane on the rotor for rotating the rotor as the drilling fluid flows therepast.

None of these conventional downhole tools, however, include an internal or structural means for improving the conveyance of pressure pulses generated by the tools, e.g., by constricting the flow of drilling fluid therethrough. Nor do these conventional downhole tools include an internal or structural means for improving the conveyance of pressure pulses generated by other portions of the drill string, e.g., generated by measurement-while-drilling downhole tools. For example, these conventional downhole tools do not structurally reduce the attenuation of signals produced by, e.g., measurement-while-drilling downhole tools.

Thus, the need exists for a downhole vibrational tool structured to improve the conveyance both of pressure pulses generated by the downhole vibrational tool and of pressure pulses generated by other downhole tools.

### SUMMARY

In some aspects, the present disclosure relates to a friction reduction tool for vibrating a drill string or coiled tubing to be lowered into a wellbore and into which a drilling fluid is pumped, the friction reduction tool comprising: a housing for connecting the friction reduction tool to the drill string or the coiled tubing; a force converter within the housing and having a first end and a second end, the force converter comprising a stator extending from the first end to the second end, a helical rotor at least partially within the stator and extending from the first end to the second end, and a rotational cavity passageway for conveying the drilling fluid between the stator and the helical rotor; and a valve assembly within the housing and connected to the second end of the force converter; wherein the helical rotor has a bore which extends through the helical rotor and which defines an alternative passageway for the drilling fluid; and wherein the rotational cavity passageway and the alternative passageway are in fluidic communication with the valve assembly. In some cases, the ratio of the volume of drilling fluid pumped through the rotational cavity passageway to the volume of drilling fluid pumped through the alternative passageway is from 1:1 to 19:1. In some cases, the diameter of the bore is less than 90% a minor diameter of the rotor. In some cases, the valve assembly comprises a valve to: (i) increase an effective cross-sectional flow area for the drilling fluid pumped through the housing, and (ii) decrease the effective cross-section flow area. In some cases, the valve assembly comprises a valve mounted within the housing and moves along a central axis of the housing between a first position that restricts passage of the drilling fluid through a vent in the housing to an exterior of the housing and a second position that allows passage of the drilling fluid through the vent. In some cases, the valve comprises a sleeve and one or more rotational cams that cause the sleeve to slide in an axial direction along the central axis of the housing between the first position and the second position In some cases, the valve assembly is structured to periodically vent the drilling fluid that is conveyed through the rotational cavity passageway and/or the alternative passageway. In some cases, the friction reduction tool further comprises a drive assembly within the housing, the drive assembly connecting the valve assembly to the force converter and structured to convert eccentric motion of the force converter to concentric motion.

In some aspects, the present disclosure relates to a drill telemetry system for transmitting downhole measurements to the surface, the drill telemetry system comprising: a measurement while drilling (MWD) downhole tool for generating a pulsed signal in a drilling fluid; a drill bit connected to the MWD downhole tool; a friction reduction tool comprising a force converter having a stator extending from the first end to the second end, a helical rotor at least partially within the stator and extending form the first end to the second end, and a rotational cavity passageway for conveying the drilling fluid between the stator and the helical rotor; wherein the helical rotor has a bore which defines an alternative passageway for the drilling fluid; wherein the MWD downhole tool and the alternative passageway are in fluidic communication; and wherein the friction reduction tool is structured to transmit the pulsed signal to the surface. In some cases, the MWD downhole tool and the alternative passageway are in fluidic communication via the drill string. In some cases, the diameter of the bore is less than 90% a minor diameter of the rotor. In some cases, the friction reduction tool further comprises a valve assembly connected to the force converter. In some cases, the valve assembly comprises a rotary valve to: (i) increase an effective cross-sectional flow area for the drilling fluid pumped through the housing when venting the drilling fluid and (ii) decrease the effective cross-section flow area when not venting. In some cases, the valve assembly comprises an axial valve mounted within the housing that moves along a central axis of the housing between a first position that restricts passage of the drilling fluid through a vent in the housing to an exterior of the housing and a second position that allows passage of the drilling fluid through the vent.

In some aspects, the present disclosure relates to a method for transmitting downhole measurements to the surface, the method comprising: pumping drilling mud through a drill string, the drill string comprising: a measurement while drilling (MWD) downhole tool; a friction reduction tool comprising a force converter having a stator extending from the first end to the second end, a helical rotor at least partially within the stator and extending form the first end to the second end, and a rotational cavity passageway for conveying the drilling fluid between the stator and the helical rotor; and drill piping connecting the MWD downhole tool to the friction reduction tool; wherein the helical rotor has a bore which defines an alternative passageway for the drilling fluid; and wherein the MWD downhole tool and the alternative passageway are in fluidic communication via the drill piping; measuring a parameter of interest with the MWD downhole tool to provide a measurement; generating a pulsed signal in the drilling mud based on the measurement; and conveying the pulsed signal through the friction reduction tool to the surface. In some cases, the pulsed signal is attenuated by less than 90% during the conveying. In some cases, the pulsed signal comprises a pattern of one or more pressure pulses in the drilling fluid. In some cases, the pattern of one or more pressure pulses comprises a positive pressure pulse, a negative pressure pulse, a continuous carrier wave, or combinations thereof.

### BRIEF DESCRIPTION OF THE DRAWINGS

The invention is described in detail below with reference to the appended drawings, wherein like numerals designate similar parts.

FIG. 1 shows a schematic view of a downhole drilling operation in accordance with various embodiments of the present disclosure.

FIG. 2 shows a cross-section of a force converter according to various embodiments of a downhole vibration tool of the present disclosure.

FIG. 3 shows the rotor of a force converter according to various embodiments of a downhole vibration tool of the present disclosure.

FIG. 4A shows a schematic of the principles for operation of a valve assembly according to various embodiments of a downhole vibration tool of the present disclosure.

FIG. 4B shows a schematic of the principles for operation of a valve assembly according to various embodiments of a downhole vibration tool of the present disclosure.

FIGS. 5A and 5B shows a schematic cross-section of a valve assembly in a closed and an open state, respectively, according to various embodiments of a downhole vibration tool of the present disclosure.

### DETAILED DESCRIPTION

### Introduction

Conventional downhole drilling operations utilize drilling fluid, such as drilling mud or a liquid fluid, to serve a number of critical downhole functions. For example, drilling fluid may be used to evacuate or “lift” the rock cuttings to the surface. During a drilling operation, the drilling fluid may be pumped down the drill string, into a central passageway formed in the center of the drill bit, and then out through openings, ports or nozzles formed in the face of the drill bit. The drilling fluid both cools the cutters and helps to remove and carry cuttings from between the blades to the surface. Drilling fluid may also be used in mud pulse telemetry systems, whereby drilling fluid acts to communicate information from downhole measurement tools to the surface.

But the use of drilling fluid does give rise to a number of issues. For example, over-pumping of drilling fluid into the drill string may result in damage to the drill string. Each drill string has a maximum volume and pressure of drilling fluid it can withstand. As the amount of fluid pumped into a drill string approaches this maximum volume or pressure, the machinery of the drill string may be damaged or may even fail. Because it is difficult to determine whether the volume or pressure of drilling fluid pumped into a drill are approaching the maximum, drill operators must be overly cautious and pump less drilling fluid into the drill string. This often results in inefficient drill operations.

Another issue is the efficient use of energy conveyed by the drilling fluid. As discussed below, pumps on the surface provide energy to the drilling fluid so that it may circulate through the drilling system. The energy from the pumps is conveyed by the drilling fluid to operate downhole tools as well as broadly to facilitate drilling. The pumps, however, are limited in the energy they can provide, in terms of flow rate and pressure. Downhole tools, such as friction reduction tools, must therefore utilize the energy conveyed by the drilling fluid efficiently.

Another issue is interference with the flow of drilling fluid. As noted, the flow of drilling fluid is important for functioning of various downhole tools. For example, a consistent flow of drill fluid is important for the conveyance of pressure pulses, such as those produced by downhole vibration tools or measurement-while-drilling tools. In conventional drilling systems, however, the other machinery in the drill string may interfere with the drilling fluid and attenuates the signals, e.g., the pressure pulses. In some cases, this attenuation reduces the effectiveness of the tool, e.g., the downhole vibration tool. In some cases, this attenuation results in difficult-to-read information, such as measurements from mud pulse telemetry systems.

Thus, the need exists for a downhole tool that can increase the maximum volume and/or pressure of drilling fluid, efficiently utilize energy conveyed by the drilling fluid, and mitigate attenuation of pressure pulses in the drilling fluid. The present disclosure provides such a tool.

### Drilling Rig

The present disclosure relates to a novel downhole vibration tool for vibrating drill strings and/or coil tubing in subterranean formations. The downhole vibration tools disclosed herein may be incorporated into a system for drilling and other downhole operations.

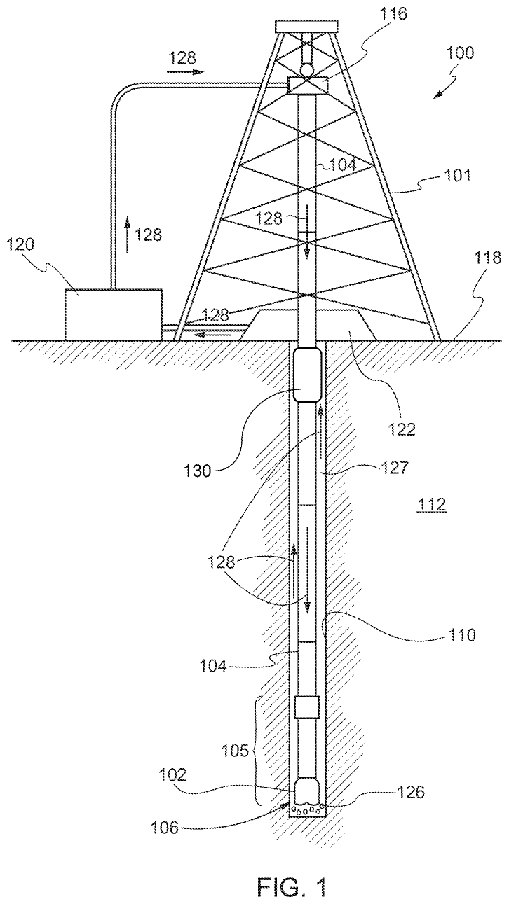

FIG. 1 is a schematic representation of a drilling rig 100 for an drilling operation. Each of the components that are shown in the schematic representation of the drilling rig 100 are intended to be generally representative of the component, and the particular example is intended to be a non-limiting, representative example of how a drilling rig might be set up for drilling with a drill bit as described herein. In various embodiments, the drilling rig 100 includes a derrick 101 that positions a drill bit 102 at the end of a drill string 104 within the hole or well bore 106 that is formed in the subterranean formation 112. During drilling operations, a drill bit 102 may be coupled to a lower end of the drill string 104. In some embodiments, the drill bit 102 is a fixed cutter bit and comprises one or more polycrystalline diamond compact (PDC) cutters comprised of sintered polycrystalline diamond (either natural or synthetic) exhibiting diamond-to-diamond bonding, polycrystalline cubic boron nitride, wurtzite boron nitride, aggregated diamond nanorods (ADN), other hard crystalline materials that may be substituted for diamond, or combinations thereof. Although various drill bits (e.g., drill bit 102) are discussed herein as comprising one or more PDC cutters it should be understood that other types of drill bits and cutters have been contemplated and are within the scope of the present disclosure. For example, the drill bit 102 may be a roller-cone bit comprised of rotating cones comprising one or more cutter made of a material such as PDC, carbide, or the like.

Drill string 104 may be several miles long and, like the well bore 106, extend in both vertical and horizontal directions from the surface 118. In this example, the drill string 104 is formed of segments of threaded pipe that are screwed together at the surface as the drill string 104 is lowered into the well bore 106. However, the drill string 104 may also comprise coiled tubing. The drill string 104 may also include components other than pipe or tubing. For example, a bottom hole assembly (BHA) 105 may be coupled to a lower end of the drill string 104 prior to the drill bit 102. The BHA 105 may include, depending on the particular application, one or more of the following components: a bit sub, a downhole motor, stabilizers, drill collar, jarring devices, directional drilling and measuring equipment, measurement-while-drilling (MWD) downhole tools, logging-while-drilling (LWD) downhole tools and other devices. The characteristics of the components of the BHA 105 contribute to determining the drilling penetration rate of the drill bit 102 and the well bore 106 shape, direction and other geometric characteristics.

During drilling, the drill bit 102 is rotated to shear, crush, or otherwise fail the subterranean formation 112 and advance the well bore 106. The drill bit 102 may be rotated in any number of ways. For example, the drill bit 102 may be rotated by rotating the drill string 104 with a top drive 116 or a table drive (not shown) or with a downhole motor that is part of the BHA 105. The drill bit 102 may be surrounded by a sidewall 110 of the well bore 106. As the drill bit 102 is rotated within the well bore 106 via the drill string 104, a drilling fluid may be pumped down the drill string 104, through the internal passageways within the drill bit 102, and out from drill bit 102 through openings, nozzles or ports. Formation cuttings 126 generated by the one or more PDC cutters of the drill bit 102 may be carried with the drilling fluid through the channels, around the drill bit 102, and back up the well bore 106 through the annular space 127 within the well bore 106 outside the drill string 104.

The drilling fluid may be pumped down the drill string 104 using conventional means, e.g., pumps. FIG. 1 illustrates a fluid source 120, which is intended to be a non-limiting representation any of the possible ways of providing energy to the drilling fluid (e.g., hydraulic or pneumatic fluid), as the drill bit 102 can be used with any of them. The drilling fluid is circulated down the well bore 106 by flowing it through the drill string 104, to the drill bit 102, where it exits through the openings, nozzles or ports to carry cuttings away from the face of the drill bit 102 and into the annular space 127, where the cuttings may be carried up to a collection point 122. The drilling fluid within the collection point 122 may be recirculated once cleaned of the cuttings.

In various embodiments, the drilling fluid comprises liquid drilling mud (i.e., a hydraulic fluid). Various conventional liquid drilling muds are known, and each of these is acceptable for use with the drill bits and the drilling system described herein. In some embodiments, for example, the liquid drilling mud may comprise water alone or in combination with other components. In some embodiments, the liquid drilling mud may comprise water in combination with clays (e.g., betonite) or other chemicals (e.g., potassium formate). In some embodiments, the liquid drilling mud may be an oil-based mixture, for example, comprising a petroleum product. In some embodiments, the liquid drilling mud may comprise a synthetic oil.

In various embodiments, the drilling fluid comprises a pneumatic fluid, e.g., a mixture of one or more gases. In some embodiments, the pneumatic fluid comprises atmospheric air. In other embodiments, the pneumatic fluid comprises one or more gases from storage tanks (such as nitrogen). In other embodiments, the gas is a combination of atmospheric gases and additional gases such as inert gases, e.g., argon or helium. In some embodiments, the pneumatic fluid is pressurized before flowing through the drill pipe. The pressurized pneumatic fluid can be generated in any number of ways, any of which may be used with the drill bit 102. For example, the fluid source 120 may comprise one or more high pressure pumps that compresses the gas.

The drilling rig 100 may also include a downhole vibration tool 130, through which drilling fluid flows. As shown in FIG. 1, the downhole vibration tool 130 is connected to the drill string 104 and is separated from the drill bit 102 and the BHA 105 such that the downhole vibration tool 130 is closer to the surface 118 during downhole operation. The downhole vibration tool 130 reduces friction between the drill string 104 and the well bore 106. During operation, eccentric rotation at the drill bit 102 and the BHA 105 produces axial vibration along the drill string 104. The axial vibration causes the drill string 104 interact with the well bore 106, creating friction that reduces the effectives of the downhole operation. The downhole vibration tool 130 reduces the friction by inducing pressure pulses in the fluid, which is then converted to axial vibration. The position of the downhole vibration tool 130 above the drill bit 102 and the BHA 105, with respect to the direction of drilling, as well as the distance between the components ensures the optimal functioning of the downhole vibration tool 130.

### Downhole Vibration Tool

The present disclosure describes a downhole vibration tool which vibrates a drill string or coil tubing to reduce friction during oil and gas drilling and well workover operations. As noted above, drilling fluid may be pumped into the drill string during operation and flows through the downhole vibration tool (also called a friction reduction tool), which produces pressure variations in the drilling fluid and thereby creates vibration.

In various embodiments, the downhole vibration tool comprises a force converter and a valve assembly. The force converter and the valve assembly are connected by, and at least partially encased within, a housing. The housing may take any shape, but in certain embodiments the housing may be substantially cylindrical. In some embodiments, the downhole vibration tool may also comprise a drive assembly, at least partially encased within the housing, to connect the force converter to the valve assembly.

During downhole operation, drilling fluid is pumped through the downhole vibration tool. In certain embodiments, the downhole vibration tool is structured such that drilling fluid flows sequentially through the force converter, then the valve assembly. Said another way, in certain embodiments, the force converter is above or upstream of the valve assembly (e.g., closer to the surface during downhole operation).

### Force Converter

In various embodiments, the downhole vibration tool comprises a force converter (also known as a power section). As drilling fluid is pumped through the downhole vibration tool, the force converter provides power to the valve assembly. In particular, the force converter is structured to convert the hydraulic energy of the drilling fluid into mechanical energy. Because the force converter is connected to the valve assembly, e.g., by the drive assembly, the mechanical energy may be used to operate the valve assembly. For example, in some embodiments, energy from the force converter rotates the valve assembly and enables the production of pressure variation in the drilling fluid, as described below.

The force converter may take any structure suitable for converting hydraulic energy from the drilling fluid into rotational energy. In preferred embodiments, the force converter is a Moineau-type positive displacement motor (also known as a PDM or a mud motor).

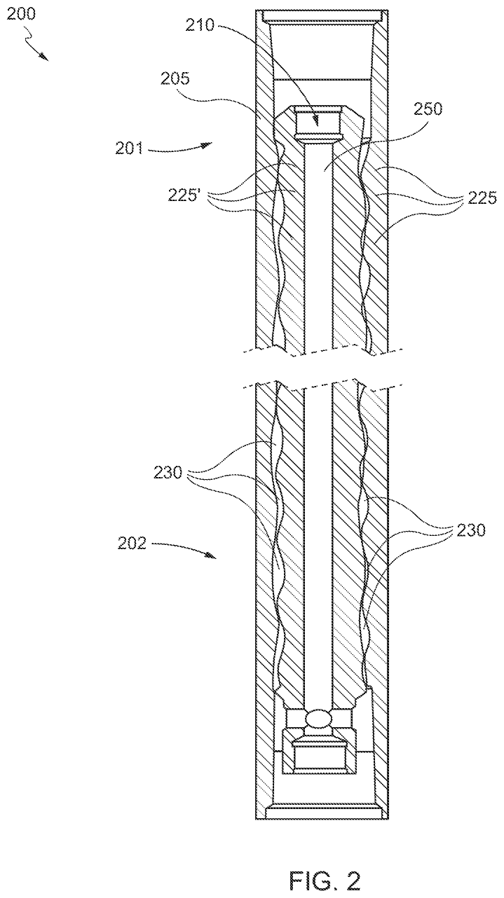

FIG. 2 illustrates a cross-section of an exemplary force converter 200. The force converter has a first end 201, into which drilling fluid may be pumped, and a second end 202, which is connected to the valve assembly (not shown). The force converter 200 comprises two components: a stator 205 and a rotor 210. The stator 205 extends from the first end 201 to the second end 202. The rotor 210 similarly extends from the first end 201 to the second end 202 and is positioned within the stator 205. Both the stator 205 and the rotor 210 comprise lobes 225 and 225′, respectively. The junction of the lobes 225, 225′ forms a series of interstitial spaces 230 between the stator 205 and the rotor 210. The interstitial spaces 230 define a rotational cavity passageway for conveying pumped drilling fluid between the stator 205 and the rotor 210. Because the drilling fluid is pumped under pressure, the drilling fluid is forced through the interstitial spaces 230 and along the rotational cavity passageway. This causes the rotor 210 to rotate within the stator 205, thereby producing rotational, mechanical energy.

According to the various embodiments of the present disclosure, and as shown in FIG. 2, the rotor 210 has a bore 250, which also runs from the first end 201 to the second end 202. The bore 250 defines an alternative passageway for drilling fluid pumped through the force converter 200.

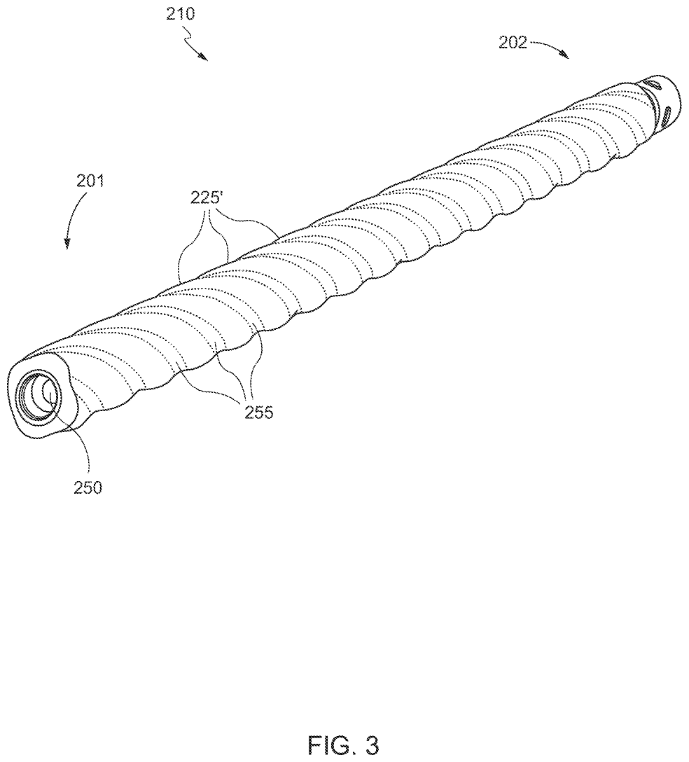

FIG. 3 illustrates a perspective view of the rotor 210 from the embodiment of FIG. 2. As can be more clearly seen in FIG. 3, the lobes 225′ of the rotor 210 are helical and define helical grooves 255. When the rotor 210 is installed in the stator (not shown), the helical grooves 255 are sealed by the lobes of the stator and partially define the interstitial spaces and the rotational cavity passageway for drilling fluid. In addition, FIG. 3 illustrates the bore 250 running from the first end 201 to the second end 202 of the force converter.

The alternative passageway defined by the bore 250 beneficially improves other performance characteristics of the downhole vibration tool. In some embodiments, the bore 250 supports a greater flow rate and/or less fluid energy consumption than would otherwise be possible. Said another way, the bore 250 may increase the maximum flow rate of drilling fluid pumped into the drill string.

The size of the bore 250 in the rotor 210 is limited by the minor diameter of the rotor 210 itself and the machining capability to produce a bore of such a size. The rotor 210 has a major diameter, which is defined by the circle that circumscribes the lobes of a cross-section of the rotor 210; the rotor 210 also has a minor diameter, which is defined by the circle inscribed in the grooves of a cross-section of the rotor 210. To maintain the structural integrity of the force converter 200, the diameter of the bore 250 should be smaller than the minor diameter.

In one embodiment, the diameter of the bore 250 is less than 50% of the major diameter of the rotor 210, e.g., less than 45%, less than 40%, less than 35%, or less than 30%. In terms of lower limits, the diameter of the bore 250 may be greater than 1% of the major diameter of rotor 210, e.g., greater than 5%, greater than 10%, or greater than 15%. In terms of ranges, the diameter of the bore 250 may be from 1% to 50% of the major diameter of the rotor 210, e.g., from 5% to 50%, from 10% to 50%, from 15% to 50%, 1% to 45%, from 5% to 45%, from 10% to 45%, from 15% to 45%, 1% to 40%, from 5% to 40%, from 10% to 40%, from 15% to 40%, 1% to 35%, from 5% to 35%, from 10% to 35%, from 15% to 35%, 1% to 30%, from 5% to 30%, from 10% to 30%, or from 15% to 30.

In one embodiment, the diameter of the bore 250 is less than 90% of the minor diameter of the rotor 210, e.g., less than 85%, less than 80%, less than 75%, or less than 70%. In terms of lower limits, the diameter of the bore 250 may be greater than 10% of the minor diameter of rotor 210, e.g., greater than 15%, greater than 20%, or greater than 25%. In terms of ranges, the diameter of the bore 250 may be from 10% to 90% of the minor diameter of the rotor 210, e.g., from 15% to 90%, from 20% to 90%, from 25% to 90%, 10% to 85%, from 15% to 85%, from 20% to 85%, from 25% to 85%, 10% to 80%, from 15% to 80%, from 20% to 80%, from 25% to 80%, 10% to 75%, from 15% to 75%, from 20% to 75%, from 25% to 75%, 10% to 70%, from 15% to 70%, from 20% to 70%, or from 25% to 70%.

As can be appreciated, the size of the bore 250 will affect the amount of drilling fluid that flows through the alternative pathway relative to the rotational pathway. In some embodiments, the size of the bore 250 may be selected to effect a certain volume ratio of the drilling fluid pumped through the rotational cavity passageway to the drilling fluid pumped through the alternative passageway. In one embodiment, the volume ratio is from 1:1 to 19:1, e.g., from 1:1 to 18:1, from 1:1 to 17:1, from 1:1 to 16:1, from 1:1 to 15:1, from 2:1 to 19:1, from 2:1 to 18:1, from 2:1 to 17:1, from 2:1 to 16:1, from 2:1 to 15:1, from 3:1 to 19:1, from 3:1 to 18:1, from 3:1 to 17:1, from 3:1 to 16:1, from 3:1 to 15:1, from 4:1 to 19:1, from 4:1 to 18:1, from 4:1 to 17:1, from 4:1 to 16:1, from 4:1 to 15:1, from 5:1 to 19:1, from 5:1 to 18:1, from 5:1 to 17:1, from 5:1 to 16:1, or from 5:1 to 15:1. In terms of lower limits, the volume ratio may be greater than 1:1, e.g., greater than 2:1, greater than 3:1, greater than 4:1, greater than 5:1. In terms of upper limits, the volume ratio may be less than 19:1, e.g., less than 18:1, less than 17:1, less than 16:1, or less than 15:1.

In some embodiments, the size of the bore 250 may be selected to effect a certain volume percentage of the drilling fluid pumped through the rotational cavity passageway relative to the total drilling fluid pumped through the downhole vibration tool. In one embodiment, the amount of drilling fluid pumped through the rotational cavity passageway is from 50% to 95% of the drilling fluid pumped through the downhole vibration tool, e.g., from 50% to 90%, from 50% to 85%, from 50% to 80%, from 55% to 90%, from 55% to 90%, from 55% to 85%, from 55% to 80%, from 60% to 90%, from 60% to 90%, from 60% to 85%, from 60% to 80%, from 65% to 90%, from 65% to 90%, from 65% to 85%, or from 65% to 80%. In terms of lower limits, at least 50% of the drilling fluid pumped through the downhole vibration tool may pass through the rotational cavity passageway, e.g., at least 55%, at least 60%, or at least 65%. In terms of upper limits at most 95% of the drilling fluid pumped through the downhole vibration tool may pass through the rotational cavity passageway, e.g., at most 90%, at most 85%, or at most 80%.

As noted above, both the rotor 210 and the stator 205 have lobes 225, 225′, and the interaction of these lobes 225, 225′ forms the rotational cavity passageway. The pattern of the lobes 225, 225′ and the length of the helical lobes 225′ of the rotor 210 may impact the function of the force converter 200. The pattern of the lobes 225, 225′ is typically described by the ratio of lobes 225, 225′ in the rotor 210 and the stator 205, with the stator 205 necessarily having one more lobe 225 more than the rotor 210. For example, the lobe ratio of the force converter 200 may be written as 4:5, meaning that the rotor 210 has 4 lobes 225′ and the stator 205 has 5 lobes 225.

As also noted above, the lobes 225′ of the rotor 210 have a generally helical shape. In various embodiments, the bore 250 through the rotor 210 is generally straight (i.e., it is not helical). This imposes a limit on the shape of the pattern of the lobes 225′ of the rotor 210. Thus, some embodiments may only be suitable for a force converter 200 with a lobe ratio of at least 1:2, e.g., at least 3:4, at least 4:5, at least 5:6, at least 6:7, at least 7:8, or at least 8:9.

Valve Assembly

In various embodiments, the downhole vibration tool further comprises a valve assembly. The valve assembly is structured to produce pressure variations in the drilling fluid by controlling, e.g., restricting, the flow of the drilling fluid. In some embodiments, the valve assembly cyclically modifies the pressure of the drilling fluid by constricting its flow through the downhole vibration tool. In some embodiments, the valve assembly cyclically modifies the pressure of the drilling fluid by venting drilling fluid, e.g., through an external vent in the housing.

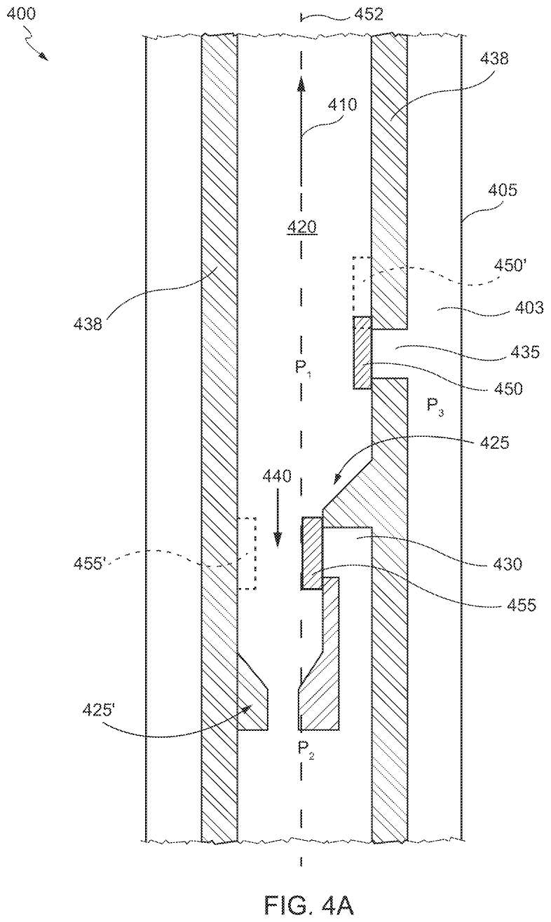

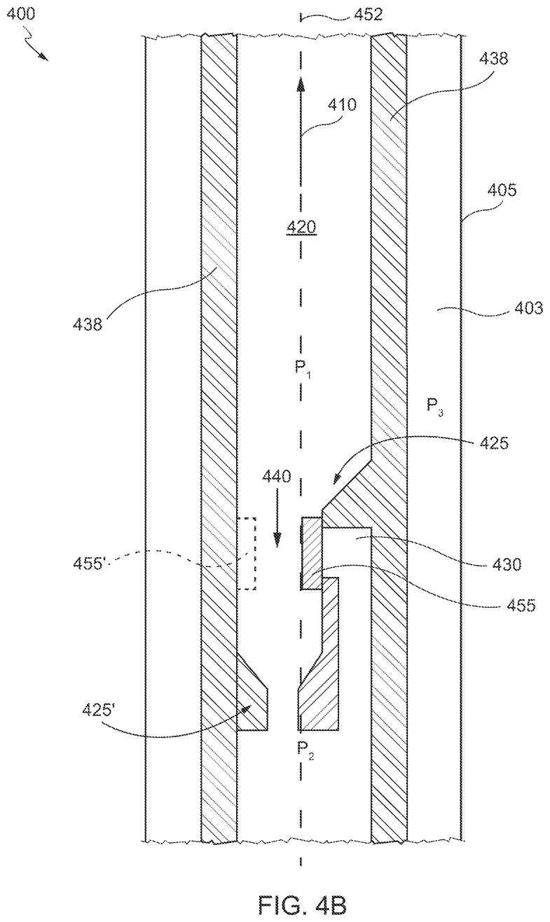

FIG. 4A illustrates a schematic of a valve assembly 400 according to various embodiments of the present disclosure. As noted above, during downhole operation, drilling fluid is pumped from the surface to a bottom hole assembly, where it exits and returns to the surface through an annulus 403 between the drill string or coiled tubing and the wall of the wellbore 405 for circulating drilling fluid back to the surface. The valve assembly 400 is used to generate cyclical pressure waves, represented by arrow 410, within the drilling fluid being pumped through the drill string or coiled tubing. In some instances, the valve assembly 400 is capable of generating cyclical pressure waves with a magnitude, as measured by the difference between the highest pressure and the lowest pressure, sufficient to cause (with or without a shock sub) vibration of the drill string or coiled tubing.

In the illustrated embodiment, the valve assembly 400 has one or more internal passageways that are collectively represented by passageway 420, through which drilling fluid may flow. References herein to “passageway” should be interpreted to collectively refer to one or more channels, conduits, or other type of pathway for drilling fluid to flow. The valve assembly 400 also comprises at least one constriction (e.g., a first constriction 425 and/or a second constriction 425′), or flow restriction, which reduces the cross-sectional flow area of drilling fluid flowing through the valve assembly 400 as compared to the cross-sectional flow area upstream from the at least one constriction. In some embodiments, only one constriction (e.g., a first constriction 425 and/or a second constriction 425′) is implemented to reduce the cross-sectional flow area of drilling fluid and thereby create a pressure wave. In other embodiments, two or more constrictions (i.e., multiple constrictions are implemented to reduce the cross-sectional flow area of drilling fluid and thereby create a pressure wave. For example, the valve assembly 400 shown in FIG. 4A includes a first constriction 425 to initially reduce the cross-sectional flow area of the drilling fluid flowing a first predetermined amount and a second constriction 425′ to further reduce the cross-sectional flow area of the drilling fluid flowing a second predetermined amount. The overall reduced cross-sectional flow area causes an increase in the pressure P₁ of the drilling fluid within the valve assembly 400 upstream from the first constriction 425. The valve assembly 400 may also comprise a channel 430 that allows drilling fluid to avoid the second constriction 425′ when the channel 430 is open. The channel 430 acts as an internal bypass of the second constriction 425′ and enlarges the cross-sectional flow area for drilling fluid flowing through the valve assembly 400.

In some embodiments, the valve assembly 400 may comprise at least one opening 435 in its exterior housing or side wall 438 that, when opened, allows drilling fluid to be communicated from the passageway 420 to exterior of the valve assembly 400, in the annulus 403. In the embodiment shown in FIG. 4A, the at least one opening 435 acts as the external vent. Because the pressure P₃ of fluids within the annulus 403 is typically much lower than the pressure P₁ of the drilling fluid, the flow of drilling fluid through the opening 435 causes a pressure drop in area 420.

During operation, the opening 435 and bypass channel 430 open and close cyclically. In the embodiment and FIG. 4A, the opening 435 and the bypass channel 430 are each closed at or near the same time to increase pressure P₁ in the drilling fluid upstream of the first constriction 425. At this point the pressure P₁ of the drilling fluid upstream of the first constriction 425 is greater than pressure P₂ of the drilling fluid downstream of the second constriction 425′ and the bypass channel 430 within the valve assembly 400 and pressure P₃ in the annulus 403. In the embodiment and FIG. 4A, the opening 435 and the bypass channel 430 are also opened at or near the same time. As a result, the pressure P₁ will suddenly drop toward the pressure P₂, because portions of the drilling fluid are being diverted externally into the annulus 403 and internally into the bypass channel 430. The drilling fluid flowing through the bypass channel 430 converges with drilling fluid passing through the second constriction 425′ in a portion of the passageway 420 that has the same or larger cross-sectional area than the combined cross-sectional areas of the bypass channel 430 and constriction channel 440, through which drilling fluid flows after passing the first constriction 425. The opening 435 and/or bypass channel 430 are cyclically opened and closed to generate a pressure waves with a high pressure point that is higher than pressure of the fluid in the drill string (drill string pressure) seen by pumps at the surface, and a low pressure point that is lower than the drill string pressure. The pressure waves create an axial vibration in the drill string or coiled tubing and that can (be used to) vibrate the drill string or coiled tubing.

Downstream tools, e.g., in the bottom hole assembly, may require or benefit from a steady flow rate of drilling fluid, and so it is preferred that the flow rate of drilling fluid through the valve assembly 400 be relatively constant. Despite small loss in drilling fluid through the opening 435, the flow rate of the drilling fluid through the valve assembly 400 stays relatively constant during the cycling of the opening 435 and bypass channel 430 in both open and closed states. In some embodiments, the size of the first constriction 425 and/or the second constriction 425′ is kept constant at least to help to maintain a steady flow rate of drilling fluid. In some embodiments, the first constriction 425 and/or the second constriction 425′ is made and assembled in manner that allows for its diameter or area of its opening to be changed during set up of the valve assembly 400. This allows the same valve assembly to be adapted for different runs. In some embodiments, the valve assembly 400 could also be constructed to allow for the size of the first constriction 425 and/or the second constriction 425′ to be changed when it is downhole.

The opening 435 shown in FIG. 4A is representative of one or more orifices defined in an exterior housing or side wall 438 of the valve assembly 400. In this embodiment, the flow of drilling fluid through the opening 435 is controlled by a valve 450 that translates within the valve assembly 400 axially, meaning that the valve 450 moves linearly along the direction of the central axis 452 of the valve assembly 400 (and drill string or coiled tubing). When in a closed position, the valve 450 mostly or substantially prevents the flow of drilling fluid through the opening 435. When in an open position, represented by dashed lines and reference number 450′, the valve 450 allows the flow of drilling fluid through the opening 435.

In the embodiment of FIG. 4A, the flow of drilling fluid through the bypass channel 430 is controlled by a valve 455. In certain embodiments, the valve 455 is a rotary valve. The valve 455 is indicated or represented in a closed position in solid lines, referenced by number 455 and an open position in dashed lines, referenced by number 455′. In this embodiment, the valve 455 is indicated as being a rotary valve that rotates about an axis parallel to the central axis 452 of the valve assembly 400. When in a closed position, the rotary valve 455 mostly or substantially prevents the flow of drilling fluid through the bypass channel 430. When in an open position, represented by dashed lines and reference number 455′, the valve 455 allows the flow of drilling fluid through the bypass channel 430.

While the embodiment of FIG. 4A illustrates an axial valve 450 controlling flow through the opening 435 and a rotary valve 455 controlling flow through the bypass channel 430, it will be appreciated that any type of valve may be used. For example, in some embodiments, a rotary valve may control the flow of drilling fluid through the opening 435. In some embodiments, an axial valve may control the flow of drilling fluid through the bypass channel 430.

It will also be appreciated that, while the embodiment of FIG. 4A illustrates a valve assembly including both an internal valve to periodically constrict flow of drilling fluid and an external valve to periodically vent drilling fluid to the annulus, any combination of these types of valves may be used. In some embodiments, the valve assembly of the downhole vibration tool comprises only an internal valve. In some embodiments, the valve assembly of the downhole vibration tool comprises only an external valve.

For example, FIG. 4B illustrates a schematic of an alternative valve assembly 400 according to various embodiments of the present disclosure. The valve assembly 400 illustrated in FIG. 4B is largely similar to that shown in FIG. 4A. As with FIG. 4A, FIG. 4B illustrates the valve assembly 400 within the annulus, through which drilling fluid returns to the surface between the drill string or coiled tubing and the wall of the wellbore 405. The valve assembly 400 is used to generate cyclical pressure waves, represented by arrow 410, within the drilling fluid being pumped through the drill string or coiled tubing.

Similar to the embodiment illustrated in FIG. 4A, the valve assembly 400 illustrated in FIG. 4B has one or more internal passageways that are collectively represented by passageway 420, through which drilling fluid may flow, and also comprises at least one constriction (e.g., a first constriction 425 and/or a second constriction 425′), which reduces the cross-sectional flow area of drilling fluid flowing through the valve assembly 400 as compared to the cross-sectional flow area upstream from the at least one constriction. In particular, the valve assembly 400 shown in FIG. 4B includes a first constriction 425 to initially reduce the cross-sectional flow area of the drilling fluid flowing a first predetermined amount and a second constriction 425′ to further reduce the cross-sectional flow area of the drilling fluid flowing a second predetermined amount. The overall reduced cross-sectional flow area causes an increase in the pressure P₁ of the drilling fluid within the valve assembly 400 upstream from the first constriction 425. The valve assembly 400 may also comprise a channel 430 that allows drilling fluid to avoid the second constriction 425′ when the channel 430 is open. The channel 430 acts as an internal bypass of the second constriction 425′ and enlarges the cross-sectional flow area for drilling fluid flowing through the valve assembly 400. The flow of drilling fluid through the bypass channel 430 is controlled by a valve 455. In FIG. 4B, the valve 455 is indicated or represented in a closed position in solid lines, referenced by number 455 and an open position in dashed lines, referenced by number 455′.

The valve assembly 400 illustrated in FIG. 4B differs from the embodiment illustrated in FIG. 4A in that it does not comprise an opening in its exterior housing or side wall. In this embodiment, the first constriction 425 and the second constriction 425′ as well as operation of the valve 455 sufficiently produce the cyclical pressure waves in the drilling fluid.

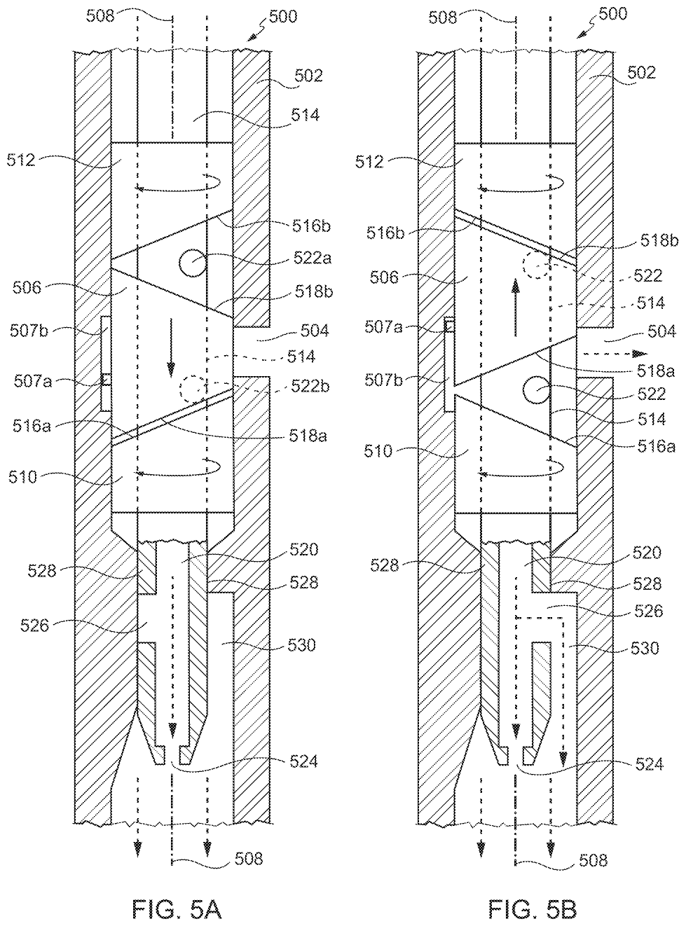

FIGS. 5A and 5B are schematic illustrations of an embodiment of a valve assembly 500 constructed to operate similarly to the embodiment of FIG. 4A. The valve assembly 500 includes an internal restriction on the flow of the drilling fluid in the tool to increase pressure, and an external vent (i.e., opening) and an internal bypass channel that are operated, respectively, by axial and rotary valves, to cyclically decrease the pressure of the drilling fluid within the tool to generate a pressure wave of sufficient amplitude to vibrate a drill string or coiled tubing to reduce friction. In FIG. 5A, the external vent and internal bypass channel are closed; in FIG. 5B the external vent and internal bypass channel are open.

The valve assembly 500 in this embodiment is encased in a housing 502, in which is defined an opening to the exterior of the tool that comprises an external vent 504 for communicating drilling fluid flowing through the tool to the annulus. This housing 502 may also (partially) encase the force converter (not shown), which is upstream of the valve assembly 500. An axial valve controls the flow of drilling fluid through the external vent 504. In the embodiments of FIGS. 5A and 5B, the axial valve comprises a sleeve 506, which translates within the housing 502 of the tool in an axial direction between a closed position (FIG. 5A) and an open position (FIG. 5B). The sleeve 506 is preferably prevented from rotating with respect to the housing 502. In this embodiment, it is prevented from rotating by a key 507a and complementary keyway 507b, which allow for axial movement along the central axis of the sleeve 506 but prevents rotation with respect to the housing 502. In some embodiments, other arrangements may be used to prevent rotation while allowing axial movement. Although the sleeve 506 is coaxial with the center axis 508 of the valve assembly in this example, it can be an axially reciprocating sleeve without being coaxial.

The sleeve 506 is reciprocated between open and closed positions by a pair of cams 510 and 512 disposed on opposite ends of the sleeve 506. The cams 510, 512 are mounted on a shaft 514 so that they rotate with the shaft 514. The shaft 514 is turned by the force converter (not shown). An end on each of the cams 510, 512 has an axially inclined cam surface 516a and 516b, respectively. In the embodiment of FIGS. 5A and 5B, each cam surface 516a, 516b is represented as an end surface that is inclined with respect to the axis along which sleeve 506 reciprocates. The cams 510 and 512 are mounted on the shaft 514 so that their inclines are rotationally 180 degrees apart. When the cams 510, 512 are rotated, the inclined portions of the cam surfaces 516a, 516b (the portion which extends further) alternately push the sleeve 506, causing the sleeve 506 to axially move back and forth. Each end surface 518a and 518b of the sleeve 506 acts as a cam follower that engages, respectively, the cam surfaces 516a and 516b. The end surfaces 518a, 518b are also shaped to accommodate the inclined portions of cam surfaces 516a, 516b, respectively, when that cam 510, 512 is not pushing the sleeve 506. This is indicated schematically in this example, by end surfaces 518a, 518b of the sleeve 506 having an angle that complements the angle of the respective cam surfaces 516a and 516b.

The operation of the cams 510, 512 can be appreciated by comparing FIGS. 5A and 5B. In FIG. 5A the incline of cam surface 516b on cam 512 has acted against the end surface 518b of the sleeve 506 to push the sleeve 506 to a position where it closes the external vent 504, and cam 510 has rotated so that its cam surface 516a accommodates the end surface 518a of the sleeve 506. As the shaft 514 continues to rotate, as shown in FIG. 5B, the cam surface 516a has pushed the sleeve 506 back to a position in which the external vent 504 is open.

The shaft 514 is hollow and defines a conduit 520 that forms a portion of the drilling fluid passageway through the vibration tool. The dashed arrows in the figures indicate generally the flow of drilling fluid through the tool. The shaft 514 may have at least one opening not blocked by the sleeve 506 as its shifts back and forth, through which drilling fluid is always able to flow into an area between the shaft 514 and the housing 502 and then out through the external vent 504 when it opens. In this example, two, axially and rotationally displaced orifices 522a and 522b can be seen, one when the external vent 504 is open and one when the external vent 504 is closed. This ensures that drilling fluid is always available for flowing through the external vent 504 when it is open. Instead of multiple, round orifices, one or more elongated orifices or slots could be used.

In the illustrated embodiment, the valve assembly 500 includes a narrowing of the passageway for the drilling fluid—a constriction area—that reduces the cross-section area through which the drilling fluid may flow through the tool to increase pressure of the drilling fluid passing through the tool. In this embodiment, the constriction area is formed by exit opening 524 at the end of the shaft 514 that has a smaller cross-sectional area than the cross-sectional area of the conduit 520. The shaft 514 also has defined in it an internal bypass orifice 526 that allows for communication of drilling fluid from inside the shaft 514 to outside the shaft 514. A shoulder 528 extends inwardly from the housing 502 to meet the shaft 514 and at least partially surrounds it to close the internal bypass orifice 526 when the shaft 514 is in a position in which the sleeve 506 closes the vent 504, as shown in FIG. 5A. However, when the shaft 514 is rotated to a position shown in FIG. 5B, in which the vent 504 is open, the internal bypass orifice 526 is aligned with internal bypass channel 530. Drilling fluid thus may flow into the internal bypass channel 530 at the same time some of it is vented through the external vent 504, thus quickly decreasing the pressure of the drilling fluid within the conduit 520. In the embodiment, the internal bypass channel 530 is defined by the shaft 514, an interior wall of the tool, and the shoulder 528. However, it could be defined in other ways. The shaft 514, internal bypass opening 526, shoulder 528, and internal bypass channel 530 collectively form a rotary valve for cyclically restricting the flow area for the drilling fluid through the valve assembly 500.

Drive Assembly

In some embodiments, the downhole vibration tool further comprises a drive assembly. In these embodiments, the drive assembly is at least partially within the housing that encases the force converter and the valve assembly. In some embodiments, the drive assembly connects the valve assembly to the force converter.

Due to its design, the force converter may generate eccentric rotation. For optimal operation, however, the valve assembly may require concentric rotation. In some embodiments, the drive assembly (also known as universal joint, drive shaft, or flex shaft) is structured to convert the eccentric rotation of the force converter to concentric motion.

### Mud Pulse Telemetry

As described above, the bottom hole assembly may include measurement-while-drilling (MWD) downhole tools. MWD downhole tools define an automated system of data collection that play an important role in conventional directional drilling. During operation, the MWD downhole tools gather data on parameters of interest. In some embodiments, the parameter of interest may relate to the position of the drill bit, e.g., the inclination (i.e., deviation from vertical) and/or the azimuth (i.e., cardinal direction). In some embodiments, the parameter of interest may relate to physical observations of the MWD downhole tool's surrounding, e.g., temperature or pressure.

The MWD downhole tools may communicate the measurements to the surface by a system of mud pulse telemetry. In this system, the MWD downhole tools generates a pulsed signal in the drilling fluid that is pumped through the drill string during operation. In some embodiments, the pulsed signal comprises a pattern of one or more pressure pulses in the drilling fluid. In some embodiments, the pattern of one or more pressure pulses comprises a positive pressure pulse, a negative pressure pulse, a continuous carrier wave, or combinations thereof.

The pulsed signal, e.g., the pressure pulses, form a pressure wave, which propagates through the drill string until reaching the surface. The wave has a magnitude defined by the difference between the highest pressure and the lowest pressure of the pressure wave. The nature of the drilling fluid and the drilling machinery is such that the pulsed signal is attenuated as it is conveyed to the surface. Said another way, the magnitude of the pressure wave decreases as the pressure wave as it propagates through the drilling fluid.

The present inventors have found that the bore in the rotor of the downhole vibration tool mitigates the attenuation of the pulsed signal from the MWD downhole tools. It is believed that the alternative passageway defined by the bore reduces interference to the pulsed signal. In some embodiments of drilling operations utilizing the downhole vibration tool of the present disclosure, the pulsed signal of the MWD downhole tools it attenuated by less than 90%, e.g., less than 80%, less than 70%, less than 60%, or less than 50%.

### Embodiments

As used below, any reference to a series of embodiments is to be understood as a reference to each of those embodiments disjunctively (e.g., “Embodiments 1-4” is to be understood as “Embodiments 1, 2, 3, or 4”).

Embodiment 1 is a friction reduction tool for vibrating a drill string or coiled tubing to be lowered into a wellbore and into which a drilling fluid is pumped, the friction reduction tool comprising: a housing for connecting the friction reduction tool to the drill string or the coiled tubing; a force converter within the housing and having a first end and a second end, the force converter comprising a stator extending from the first end to the second end, a helical rotor at least partially within the stator and extending from the first end to the second end, and a rotational cavity passageway for conveying the drilling fluid between the stator and the helical rotor; and a valve assembly within the housing and connected to the second end of the force converter; wherein the helical rotor has a bore which extends through the helical rotor and which defines an alternative passageway for the drilling fluid; and wherein the rotational cavity passageway and the alternative passageway are in fluidic communication with the valve assembly.

Embodiment 2 is the friction reduction tool of embodiment(s) 1, wherein the ratio of the volume of drilling fluid pumped through the rotational cavity passageway to the volume of drilling fluid pumped through the alternative passageway is from 1:1 to 19:1.

Embodiment 3 is the friction reduction tool of embodiment(s) 1-2, wherein the diameter of the bore is less than 90% a minor diameter of the rotor.

Embodiment 4 is the friction reduction tool of embodiment(s) 1-3, wherein the valve assembly comprises a valve to: (i) increase an effective cross-sectional flow area for the drilling fluid pumped through the housing, and (ii) decrease the effective cross-section flow area.

Embodiment 5 is the friction reduction tool of embodiment(s) 1-4, wherein the valve assembly comprises a valve mounted within the housing that moves along a central axis of the housing between a first position that restricts passage of the drilling fluid through a vent in the housing to an exterior of the housing and a second position that allows passage of the drilling fluid through the vent.

Embodiment 6 is the friction reduction tool of embodiment(s) 5, wherein the valve comprises a sleeve and one or more rotational cams that cause the sleeve to slide in an axial direction along the central axis of the housing between the first position and the second position

Embodiment 7 is the friction reduction tool of embodiment(s) 1-6, wherein the valve assembly is structured to periodically vent the drilling fluid that is conveyed through the rotational cavity passageway and/or the alternative passageway.

Embodiment 8 is the friction reduction tool of embodiment(s) 1-7, further comprising a drive assembly within the housing, the drive assembly connecting the valve assembly to the force converter and structured to convert eccentric motion of the force converter to concentric motion.

Embodiment 9 is a drill telemetry system for transmitting downhole measurements to the surface, the drill telemetry system comprising: a measurement while drilling (MWD) downhole tool for generating a pulsed signal in a drilling fluid; a drill bit connected to the MWD downhole tool; a friction reduction tool comprising a force converter having a stator extending from the first end to the second end, a helical rotor at least partially within the stator and extending form the first end to the second end, and a rotational cavity passageway for conveying the drilling fluid between the stator and the helical rotor; wherein the helical rotor has a bore which defines an alternative passageway for the drilling fluid; wherein the MWD downhole tool and the alternative passageway are in fluidic communication; and wherein the friction reduction tool is structured to transmit the pulsed signal to the surface.

Embodiment 10 is the drill telemetry system of embodiment 9, wherein the MWD downhole tool and the alternative passageway are in fluidic communication via the drill string.

Embodiment 11 is the drill telemetry system of embodiment(s) 9-10, wherein the diameter of the bore is less than 90% a minor diameter of the rotor.

Embodiment 12 is the drill telemetry system of embodiment(s) 9-11, wherein the friction reduction tool further comprises a valve assembly connected to the force converter and configured to periodically vent the drilling fluid.

Embodiment 13 is the drill telemetry system of embodiment(s) 12, wherein the valve assembly comprises a rotary valve to: (i) increase an effective cross-sectional flow area for the drilling fluid pumped through the housing when venting the drilling fluid and (ii) decrease the effective cross-section flow area when not venting.

Embodiment 14 is the drill telemetry system of embodiment(s) 12, wherein the valve assembly comprises an axial valve mounted within the housing that moves along a central axis of the housing between a first position that restricts passage of the drilling fluid through a vent in the housing to an exterior of the housing and a second position that allows passage of the drilling fluid through the vent.

Embodiment 15 is a method for transmitting downhole measurements to the surface, the method comprising: pumping drilling mud through a drill string, the drill string comprising: a measurement while drilling (MWD) downhole tool; a friction reduction tool comprising a force converter having a stator extending from the first end to the second end, a helical rotor at least partially within the stator and extending form the first end to the second end, and a rotational cavity passageway for conveying the drilling fluid between the stator and the helical rotor; and drill piping connecting the MWD downhole tool to the friction reduction tool; wherein the helical rotor has a bore which defines an alternative passageway for the drilling fluid; and wherein the MWD downhole tool and the alternative passageway are in fluidic communication via the drill piping; measuring a parameter of interest with the MWD downhole tool to provide a measurement; generating a pulsed signal in the drilling mud based on the measurement; and conveying the pulsed signal through the friction reduction tool to the surface.

Embodiment 16 is the method of embodiment(s) 15, wherein the pulsed signal is attenuated by less than 90% during the conveying.

Embodiment 17 is the method of embodiment(s) 15-16, wherein the pulsed signal comprises a pattern of one or more pressure pulses in the drilling fluid.

Embodiment 18 is the method of embodiment(s) 17, wherein the pattern of one or more pressure pulses comprises a positive pressure pulse, a negative pressure pulse, a continuous carrier wave, or combinations thereof

We claim:

1. A friction reduction tool for vibrating a drill string or coiled tubing to be lowered into a wellbore and into which a drilling fluid is pumped, the friction reduction tool comprising:
a housing for connecting the friction reduction tool to the drill string or the coiled tubing;
a force converter within the housing and having a first end and a second end, the force converter comprising a stator extending from the first end to the second end, a helical rotor at least partially within the stator and extending from the first end to the second end, and a rotational cavity passageway for conveying the drilling fluid between the stator and the helical rotor; and
a valve assembly within the housing and connected to the second end of the force converter;
wherein the helical rotor has a bore which extends through the helical rotor and which defines an alternative passageway for the drilling fluid; and
wherein the rotational cavity passageway and the alternative passageway are in fluidic communication with the valve assembly.

2. The friction reduction tool of claim 1, wherein the ratio of the volume of drilling fluid pumped through the rotational cavity passageway to the volume of drilling fluid pumped through the alternative passageway is from 1:1 to 19:1.

3. The friction reduction tool of claim 1, wherein the diameter of the bore is less than 90% a minor diameter of the rotor.

4. The friction reduction tool of claim 1, wherein the valve assembly comprises a valve to: (i) increase an effective cross-sectional flow area for the drilling fluid pumped through the housing, and (ii) decrease the effective cross-section flow area.

5. The friction reduction tool of claim 1, wherein the valve assembly comprises a valve mounted within the housing that moves along a central axis of the housing between a first position that restricts passage of the drilling fluid through a vent in the housing to an exterior of the housing and a second position that allows passage of the drilling fluid through the vent.

6. The friction reduction tool of claim 5, wherein the valve comprises a sleeve and one or more rotational cams that cause the sleeve to slide in an axial direction along the central axis of the housing between the first position and the second position

7. The friction reduction tool of claim 1, wherein the valve assembly is structured to periodically vent the drilling fluid that is conveyed through the rotational cavity passageway and/or the alternative passageway.

8. The friction reduction tool of claim 1, further comprising a drive assembly within the housing, the drive assembly connecting the valve assembly to the force converter and structured to convert eccentric motion of the force converter to concentric motion.

9. A drill telemetry system for transmitting downhole measurements to the surface, the drill telemetry system comprising:
a measurement while drilling (MWD) downhole tool for generating a pulsed signal in a drilling fluid;
a drill bit connected to the MWD downhole tool;
a friction reduction tool comprising a force converter having a stator extending from the first end to the second end, a helical rotor at least partially within the stator and extending form the first end to the second end, and a rotational cavity passageway for conveying the drilling fluid between the stator and the helical rotor;
wherein the helical rotor has a bore which defines an alternative passageway for the drilling fluid;
wherein the MWD downhole tool and the alternative passageway are in fluidic communication; and
wherein the friction reduction tool is structured to transmit the pulsed signal to the surface.

10. The drill telemetry system of claim 9, wherein the MWD downhole tool and the alternative passageway are in fluidic communication via the drill string.

11. The drill telemetry system of claim 9, wherein the diameter of the bore is less than 90% a minor diameter of the rotor.

12. The drill telemetry system of claim 9, wherein the friction reduction tool further comprises a valve assembly connected to the force converter.

13. The drill telemetry system of claim 12, wherein the valve assembly comprises a rotary valve to: (i) increase an effective cross-sectional flow area for the drilling fluid pumped through the housing when venting the drilling fluid and (ii) decrease the effective cross-section flow area when not venting.

14. The drill telemetry system of claim 12, wherein the valve assembly comprises an axial valve mounted within the housing that moves along a central axis of the housing between a first position that restricts passage of the drilling fluid through a vent in the housing to an exterior of the housing and a second position that allows passage of the drilling fluid through the vent.

15. A method for transmitting downhole measurements to the surface, the method comprising:
pumping drilling mud through a drill string, the drill string comprising:
a measurement while drilling (MWD) downhole tool;
a friction reduction tool comprising a force converter having a stator extending from the first end to the second end, a helical rotor at least partially within the stator and extending form the first end to the second end, and a rotational cavity passageway for conveying the drilling fluid between the stator and the helical rotor; and
drill piping connecting the MWD downhole tool to the friction reduction tool;
wherein the helical rotor has a bore which defines an alternative passageway for the drilling fluid; and
wherein the MWD downhole tool and the alternative passageway are in fluidic communication via the drill piping;
measuring a parameter of interest with the MWD downhole tool to provide a measurement;
generating a pulsed signal in the drilling mud based on the measurement; and
conveying the pulsed signal through the friction reduction tool to the surface.

16. The method of claim 15, wherein the pulsed signal is attenuated by less than 90% during the conveying.

17. The method of claim 15, wherein the pulsed signal comprises a pattern of one or more pressure pulses in the drilling fluid.

18. The method of claim 17, wherein the pattern of one or more pressure pulses comprises a positive pressure pulse, a negative pressure pulse, a continuous carrier wave, or combinations thereof.
